(19) United States
(12) Patent Application Publication
(10) Pub. No.: US 2013/0160732 A1
(43) Pub. Date: Jun. 27, 2013

(54) TIMER ACTIVATED VEHICLE STARTER

(71) Applicant: Jamie Colin Tucker, Fort McMurray (CA)

(72) Inventor: Jamie Colin Tucker, Fort McMurray (CA)

(21) Appl. No.: 13/333,823

(22) Filed: Dec. 21, 2011

(51) Int. Cl. F02N 11/08

(52) U.S. Cl. 123/179.2

(57) ABSTRACT

A system and method for remotely starting a vehicle. The system comprises a receiver associated with the vehicle adapted to receive input representing a vehicle start condition and to output start data representing the input. The system further comprising a timer adapted to output a time signal and a vehicle starter processor circuit adapted to receive the start data from the receive and the time signal from the timing circuit. The vehicle starter processor circuit is adapted to start the vehicle in response to the time signal and the input. The method comprises transmitting from a handheld device start data representing at least a start time, receiving the start data at a receiver associated with the vehicle and configuring a vehicle starter processor circuit to start the vehicle according to the start data.

### BACKGROUND OF THE INVENTION

1. Field of Invention

The present invention relates to vehicle starters in general and in particular to a method and apparatus for starting vehicle components according to a predetermined schedule and for a predetermined period of time.

2. Description of Related Art

Many people own and operate vehicles in climates which have extreme weather conditions. In particular, persons living in northern climates may be subjected to cold temperatures and those living in southern climates may be subjected to hot temperatures. In such environments, it is common for many people to start their car a period of time before they are about to drive somewhere so that they vehicle may have a chance to warm up or cool down before the trip is undertaken. For such uses, remote starters are well known in the art.

Conventional remote vehicle starters typically utilize a device which is adapted to provide a start signal the vehicles upon receipt of a start signal from a remote transmitter controlled by the user. Such a transmitter is typically carried by the user, such as on their key chain. When the user wants to start their car, they press a button on the transmitter which causes it to transmit a radio frequency signal. The radio frequency signal is received by the device and thereby caused to start the vehicle. Typically, the user will press the button a desired amount of time ahead of when they wish to use the vehicle so as to provide it with sufficient time to warm up or cool down as the need may be.

The current method has been unsatisfactory in achieving a desired degree preparation of the vehicle for use for several reasons. In particular, the present method requires that the user plan ahead by an appropriate amount of time before using the vehicle. This requires a degree of planning for each and every time the user wishes to use the vehicle. Such planning may reduce the effectiveness of such systems to the memory of the user and ability to gauge the amount of time necessary to prepare the vehicle. Furthermore, such conventional vehicle starters do not prepare the vehicle to a specified temperature inside, but rather continue to heat or cool until the user arrives. This may leave the vehicle in a temperature which is substantially higher or lower than the desired temperature. The limited distance that conventional vehicle starter transmitters are able to transmit over also limits their use to vehicles which are within such transmission distances.

### SUMMARY OF THE INVENTION

According to a first embodiment of the present invention there is disclosed a system for remotely starting a vehicle comprising a receiver associated with the vehicle adapted to receive input representing a vehicle start condition and to output start data representing the input. The system further comprising a timer adapted to output a time signal and a vehicle starter processor circuit adapted to receive the start data from the receive and the time signal from the timing circuit. The vehicle starter processor circuit being adapted to start the vehicle in response to the time signal and the input.

The receiver may comprise a radio frequency receiver. The radio frequency receiver may be adapted to receive the input from a mobile device. The receiver may comprise an input device located within the vehicle. The input device may comprise a user interface screen.

The system may further comprise a sensor for sensing at least one condition within the vehicle wherein the processor circuit is adapted to turn off the vehicle when the at least one condition in the vehicle reaches a predetermined value. The sensor may comprise a temperature sensor and wherein the at least one condition comprises a temperature in an interior of the vehicle.

The time signal may represent the time of day. The start data may represent a run time for the vehicle wherein the vehicle starter processor circuit is further configured to turn the vehicle off at an end of the run time.

The system may further comprise a transmitter adapted to receive data from the vehicle starter processor circuit representing a status of the vehicle and to cause the status to be displayed to the user. The system may further comprise means for interfacing the vehicle starter processor circuit with at least one auxiliary device of the vehicle. The vehicle starter processor circuit may be operable to start the at least one auxiliary device with the vehicle and to stop the at least one auxiliary device with the vehicle.

According to a further embodiment of the present invention there is disclosed a method for remotely starting a vehicle comprising transmitting from a handheld device start data representing at least a start time, receiving the start data at a receiver associated with the vehicle and configuring a vehicle starter processor circuit to start the vehicle according to the start data.

The method may further comprise transmitting to the hand held device status data representing the status of the vehicle starter processor circuit. The start data may further include a duration of time for the vehicle to be run. The start data may further include data representing auxiliary systems of the vehicle to be started along with the vehicle.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a schematic view of a system for remotely starting a vehicle according to a first embodiment of the present invention.

FIG. 2 is a screen shot of a hand held device for use with the system of FIG. 1.

FIG. 3 is a screen shot of a vehicle mounted input screen for use with the system of FIG. 1.

### DETAILED DESCRIPTION

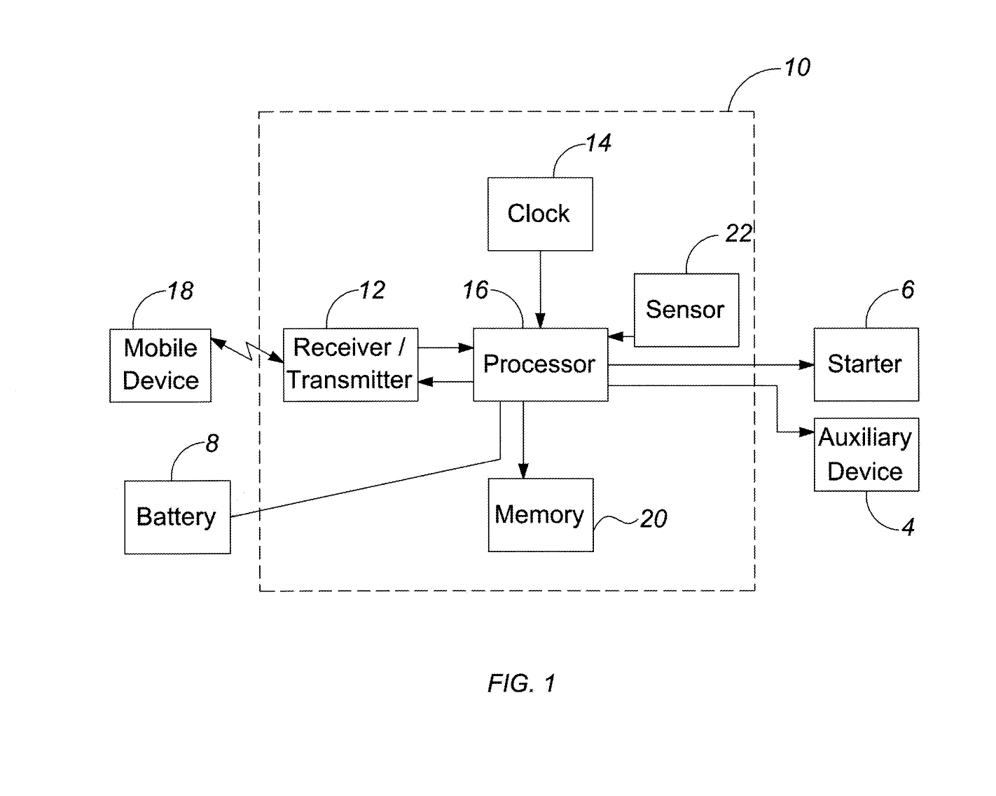

Referring to FIG. 1, a system for remotely starting a vehicle (not shown) according to a first embodiment of the present invention is illustrated generally at 10. The system 10 includes a receiver 12 and a timing circuit 14, which may comprise, by way of non-limiting example, a clock operably connected to a vehicle starter processor circuit 16 having an output adapted to provide a start signal to a starter of the vehicle as are commonly known. A battery 8, vehicle alternator or other suitable power supply may provide power to the system 10. Further methods of supplying power to the apparatus will be apparent to those of skill in the art.

The receiver 12 receives input data from a user corresponding to the desired start and run time as well as any other conditions or steps which are to define the vehicle start sequence and outputs start data to the vehicle starter processor circuit 16. The vehicle starter processor circuit 16 is configured to receive the start data from the receiver and cause a vehicle start circuits 6 to start the vehicle at a time as defined by the start data and determined against the timing circuit 14 as will be more fully described below. After a predetermined amount of time as defined by the start data ad determined against the timing circuit 14, the vehicle starter processor circuit 16 may cause the vehicle start circuits 6 to turn the vehicle off.

In the present invention, the vehicle starter processor circuit includes a microprocessor although it will be appreciated that other controllers or discreet electronics will be suitable as well. More generally, in this specification, including the claims, the term “processor circuit” is intended to broadly encompass any type of device or combination of devices capable of performing the functions described herein, including (without limitation) other types of microprocessors, microcontrollers, other integrated circuits, other types of circuits or combinations of circuits, logic gates or gate arrays, or programmable devices of any sort, either alone or in combination with other such devices located at the same location or remotely from each other. Additional types of processor circuits will be apparent to those ordinarily skilled in the art upon review of this specification, and substitution of any such other types of processor circuits is considered not to depart from the scope of the present invention as defined by the claims appended hereto.

As set out above, the receiver 12 receives the input from the user for transmission to the processing circuits. In some embodiments, the receiver comprise a user interface within the vehicle, such as by way of non-limiting example, a touch liquid crystal display screen located within the vehicle. In other embodiments, the receiver may comprise a radio frequency receiver adapted to receive signals transmitted by a handheld device 18 operated by the user. By way of non-limiting example, the handheld device 18 may comprises a cellular phone, computer personal data assistant (PDA) tablet pc, or a smart phone. It will be appreciated that any known transmission or signal type between the handheld device 18 and the receiver may be utilized and may optionally include encryption or security codes for verifying the correct user is attempting to provide the start data to the vehicle.

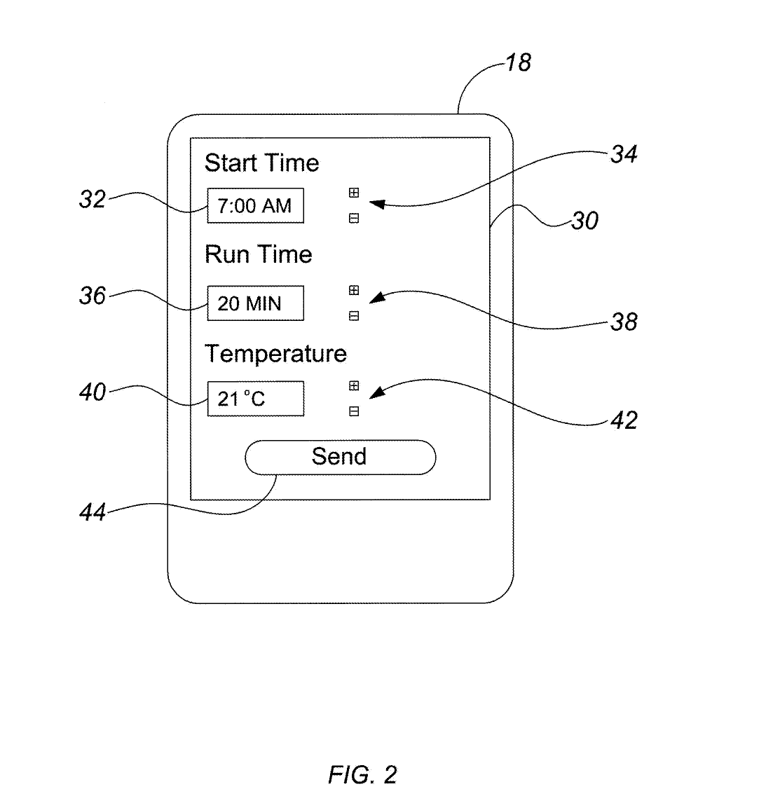

With reference to FIG. 2, a view of a screen shot of a handheld device is illustrated for interfacing with the present system. In such embodiments, the handheld device 18 may include a display screen 30 having a start time display 32 and start time buttons or controls 34 to increase or decrease the start time. The display screen 30 may also display a run time or duration 36 and run time buttons or controls 38 to increase or decrease the run time. The display screen 30 may also display a temperature setting 40 or a desired interior temperature that the vehicle is to and temperature buttons or controls 42 to increase or decrease the temperature setting. A send button 44 on the control screen permits the user to send the settings inputted therein to the receiver 12 for incorporation into the vehicle starter processor circuit 16.

With reference back to FIG. 1, the system 10 may also include a memory device 20 for storing data representing the start condition as provided or programmed into the apparatus by a user through the receiver or a mobile device as set out above. It will be appreciated that many types of memory devices 20 may be utilized to direct the processor circuit 16 to perform the functions associated with the various routines described herein. Alternatively, such routines may be provided as software stored on a different medium such random access memories (RAMs), programmable read-only memories such as EPROMs, EEPROMs or FLASH memories, for example, or any other type of memory device, either at the location of the processor circuit or located remotely therefrom, may be substituted if desired. It will also be appreciated that the functions of the processor circuit 16 and memory 20 may be provided by an application specific logic array designed to provide the functions as set out below, such as by way of non-limiting example an application specific integrated circuit.

In some embodiments, the system 10 may include a sensor 22 adapted to measure one or more conditions within the vehicle, such as, by way of non-limiting example, the temperature of the interior of the vehicle. The processor circuit 16 of the vehicle may also include an output to at least one auxiliary device 4 of the vehicle so as to start that auxiliary device along with the vehicle. By way of non-limiting example, the auxiliary device may include the air conditioning compressor for the vehicle or heater fan, window or mirror defrosters, door locks, trunk release or seat heaters.

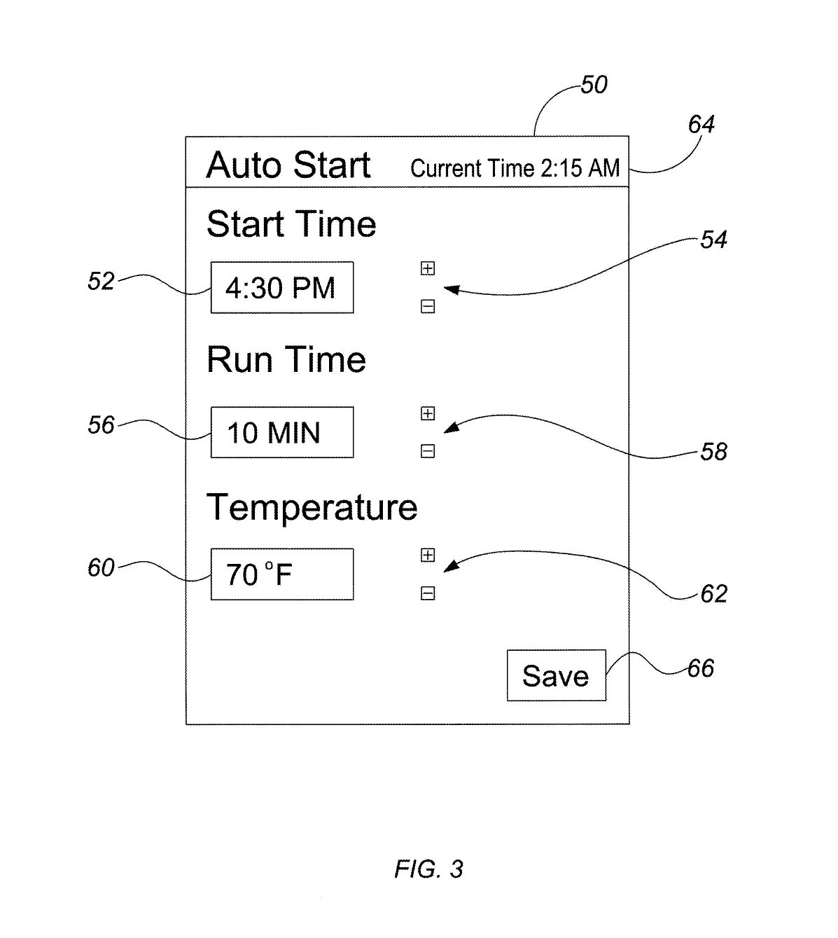

With reference to FIG. 3, a view of a screen shot of a vehicle mounted interface 50 is illustrated for interfacing with the present system. It will be appreciated that the interface 50 may comprise an interactive screen located within the interior of the vehicle and may therefore utilize a pre-existing interface screen in such vehicles as are commonly know. In such embodiments, it will also be appreciated that the interface 50 will take the place of the receiver 12 as a means for providing program information to the vehicle starter processor circuit 16 and may display to a user a start time display 52 and start time buttons or controls 54 to increase or decrease the start time. The interface may also display a run time or duration 56 and run time buttons or controls 58 to increase or decrease the run time. The interface 50 may also display a temperature setting 60 or a desired interior temperature that the vehicle is to and temperature buttons or controls 62 to increase or decrease the temperature setting. A save button 66 on the control screen permits the user to save the settings inputted therein into the vehicle starter processor circuit 16 and optionally a current time 64 may be displayed for use by the user in programming their desired start conditions.

In operation, a user selects their desired start time, run time as well as any other conditions that they want the vehicle follow during the automatic start period, such as warming up to a desired interior temperature in either their handheld device 18 or interface screen 50 and submits them to the system. The receiver 12 receives the received signal to the processor circuits 16 which stores those conditions in the memory 20 for future use. When the timing circuit 14 indicates to the processor circuits 16 that the desired start time has been reached as stored in the memory 20, the processor circuits 16 cause the vehicle start circuits 6 or other auxiliary devices 4 to be started according to the start program stored in the memory 20. When the timing circuit 14 indicates to the processor circuits 16 that the desired run time has elapsed as stored in the memory 20, the processor circuits 16 cause the vehicle start circuits 6 or other auxiliary devices 4 to be stopped according to the start program stored in the memory 20. Optionally, when sensor 22 detects that its desired condition has been satisfied, the processor circuits 16 may either cause the entire vehicle or only the auxiliary device 4 affecting that sensor to shut off. It will be appreciated that the system of the present invention may optionally be programmed to start the one or more auxiliary devices 4 at different times from the rest of the vehicle and from each other as well. The system may also optionally include a transmitter for transmitting to the handheld device 18, the status of the vehicle either during its start sequence or upon any changes being made to the start program. It will be appreciated that the receiver and transmitter may comprise a unitary device as are commonly known.

While specific embodiments of the invention have been described and illustrated, such embodiments should be considered illustrative of the invention only and not as limiting the invention as construed in accordance with the accompanying claims.

What is claimed is:

1. A system for remotely starting a vehicle comprising:
a receiver associated with the vehicle adapted to receive input representing a vehicle start condition and to output start data representing said input;
a timer adapted to output a time signal;
a vehicle starter processor circuit adapted to receive said start data from said receive and said time signal from said timing circuit,
said vehicle starter processor circuit being adapted to start said vehicle in response to said time signal and said input.

2. The system of claim 1 wherein said receiver comprises a radio frequency receiver.

3. The system of claim 3 wherein said radio frequency receiver is adapted to receive said input from a mobile device.

4. The system of claim 1 wherein said receiver comprises an input device located within said vehicle.

5. The system of claim 3 wherein said input device comprises a user interface screen.

6. The system of claim 1 further comprising a sensor for sensing at least one condition within the vehicle wherein said processor circuit is adapted to turn off said vehicle when said at least one condition in said vehicle reaches a predetermined value.

7. The system of claim 6 wherein said sensor comprises a temperature sensor and wherein said at least one condition comprises a temperature in an interior of said vehicle.

8. The system of claim 1 wherein said time signal represents the time of day.

9. The system of claim 1 wherein said start data represents a run time for said vehicle wherein said vehicle starter processor circuit is further configured to turn said vehicle off at an end of said run time.

10. The system of claim 1 further comprising a transmitter adapted to receive data from said vehicle starter processor circuit representing a status of said vehicle and to cause said status to be displayed to said user.

11. The system of claim 1 further comprising means for interfacing said vehicle starter processor circuit with at least one auxiliary device of said vehicle.

12. The system of claim 1 wherein said vehicle starter processor circuit is operable to start said at least one auxiliary device with said vehicle and to stop said at least one auxiliary device with said vehicle.

13. A method for remotely starting a vehicle comprising:
transmitting from a handheld device start data representing at least a start time;
receiving said start data at a receiver associated with said vehicle; and
configuring a vehicle starter processor circuit to start said vehicle according to said start data.

14. The method of claim 13 further comprising transmitting to said hand held device status data representing the status of the vehicle starter processor circuit.

15. The method of claim 13 wherein said start data further includes a duration of time for the vehicle to be run.

16. The method of claim 13 wherein said start data further includes data representing auxiliary systems of the vehicle to be started along with the vehicle.
